(19) United States
(12) Patent Application Publication
(10) Pub. No.: US 2018/0125009 A1
(43) Pub. Date: May 10, 2018

(54) WINDOW STRIP CORN HUSKER

(71) Applicant: Hughes Equipment Company, Columbus, OH (US)

(72) Inventors: Mark Hill, Horicon, WI (US); Todd Belz, Sun Prairie, WI (US)

(73) Assignee: Hughes Equipment Company, Columbus, WI (US)

(21) Appl. No.: 15/865,996

(22) Filed: Jan. 9, 2018

Related U.S. Application Data
(62) Division of application No. 15/042,123, filed on Feb. 11, 2016.
(60) Provisional application No. 62/114,678, filed on Feb. 11, 2015.

(51) Int. Cl. A01F 11/00

(52) U.S. Cl. CPC A01F 11/00

(57) ABSTRACT

A window strip corn husker has a pair of pinch rollers for removing a portion of a corn husk, but leaving the majority of the husk intact. The window strip corn husker includes blades for removing the at least one of the ends of an ear of corn and rollers for removing part of the husk.

### CROSS REFERENCE TO RELATED APPLICATION

This application is a divisional application and claims priority to U.S. patent application Ser. Number 15/042,123, filed on Feb. 11, 2016, which is based on and claims priority to U.S. Provisional Patent Application No. 62/114,678 filed on Feb. 11, 2015, which is incorporated herein by reference in its entirety for all purposes.

### FIELD OF INVENTION

The present invention relates generally to the field of fresh market corn processing. More particularly, the present invention relates to an apparatus and method for removing a strip of husk from a cob of corn to expose the kernels of corn in a “window” to be viewed by the customer purchasing the corn, and allowing a conversion of the machine to cut the ends of the cob without husking the window.

### BACKGROUND

Recently, grocers have begun requesting partially husked corn with a window of exposed kernels because it is an appealing way of presenting the quality, size, and color of the kernels to customers without destroying a “fresh from the farm” appearance. Currently, suppliers who present corn this way must create the window by hand. Existing automatic corn husking machines cannot be used as a cob saw without husking the corn, and when existing machines cut the ends of corn the ends are not perpendicular to the axis of the cob.

Previous attempts to create a machine that only partially removes the husk from an ear of corn suffer from a number of significant limitations. Such machines have included two saws to remove the cut end and butt end of an ear of corn. The saws are disposed one after the other, so only one saw cuts the ear of corn at a time. Such a configuration has a tendency to se the ear of corn to rotate as it passes under each sawblade, which makes it difficult to consistently align a portion of the husk with a pair of pinch rollers that remove only a portion of the husk.

Additionally, the pinch rollers used on existing partial corn husking machines wear out quickly. Such a short usable life for the pinch rollers and the significant disassembly and cleaning of the machine in order to replace the rollers as required by existing designs results in long periods of downtime, typically in the range of one to four hours.

As such, there is a need for a machine that can partially husk corn to display a window of kernels faster and more consistently than what can be achieved using existing machines or hand labor. In addition, there is a need for a machine that can perform the aforementioned window husking with reduced downtime compared to existing partial corn husking machines.

### SUMMARY

The present invention relates to an automatic corn husking machine for partially husking an ear of corn having a crosscut end and a butt end and including a cob to which a plurality of kernels is attached and a husk covering the plurality of kernels. The automatic corn husking machine includes a conveyor having a crosscut side and a butt end side. A crosscut end blade is positioned parallel to the crosscut side of the conveyor and further positioned so that when the ear of corn passes under the crosscut end blade it cuts approximately 80% of the husk and also fully severs a tip portion of the cob which leaves the severed tip portion hanging inside the partially cut husk hanging along the crosscut side of the conveyor. A cob pusher is positioned downstream from the crosscut end blade and pushes the ear of corn toward a guide plate. An inner guide block causes the tip portion to be completely removed from the husk, but leaves an un-severed portion of the husk intact. A pair of pinch rollers is positioned downstream from the guide plate and inner guide block. The pair of pinch rollers are positioned to accept the un-severed portion of husk. The pair of pinch rollers rotate in opposing directions and are positioned to engage the un-severed portion of husk. When the pinch rollers engage the un-severed portion of husk, they pull and remove the un-severed portion of husk from the ear of corn, thereby exposing a strip of kernels on the cob.

It will be understood by those skilled in the art that one or more aspects of this invention can meet certain objectives, while one or more other aspects can lead to certain other objectives. Other objects, features, benefits and advantages of the present invention will be apparent in this summary and descriptions of the disclosed embodiment, and will be readily apparent to those skilled in the art. Such objects, features, benefits and advantages will be apparent from the above as taken in conjunction with the accompanying figures and all reasonable inferences to be drawn therefrom.

### BRIEF DESCRIPTION OF THE DRAWINGS

FIG. 1 is a perspective view of one embodiment of a window strip husking machine in accordance with the invention;

FIG. 2 is a detail perspective view of the window strip husking machine of FIG. 1 showing how a corn cob is partially husked using a blade and a pair of pinch rollers;

FIG. 3 is a schematic showing fresh packed partially husked ears of corn with a window of kernels exposed;

FIG. 4 is a detail perspective view of the window strip husking machine of FIG. 1 showing how a partially removed husk is conveyed toward a set of pinch rollers;

FIG. 5 is another detail perspective view of the window strip husking machine of FIG. 1;

FIG. 6 is a side view of the window strip husking machine of FIG. 1;

FIG. 7 is a top view of the window strip husking machine of FIG. 1;

FIG. 8 is a detail perspective view of the window strip husking machine of FIG. 1 showing a channel that helps guide a partially removed husk toward a set of pinch rollers;

FIG. 9 is a detail perspective view the window strip husking machine of FIG. 1 showing the rotation of the pinch rollers;

FIG. 10 is another detail perspective view of the window strip husking machine of FIG. 1 showing how the pinch rollers can be removed and replaced;

FIG. 11 is a side detail view of the window strip husking machine of FIG. 1 showing a mechanism used to hold corn in holding troughs of a conveyor and prevent corn from rotating; and

FIG. 12 is a top detail view of the mechanism of FIG. 11.

### DETAILED DESCRIPTION

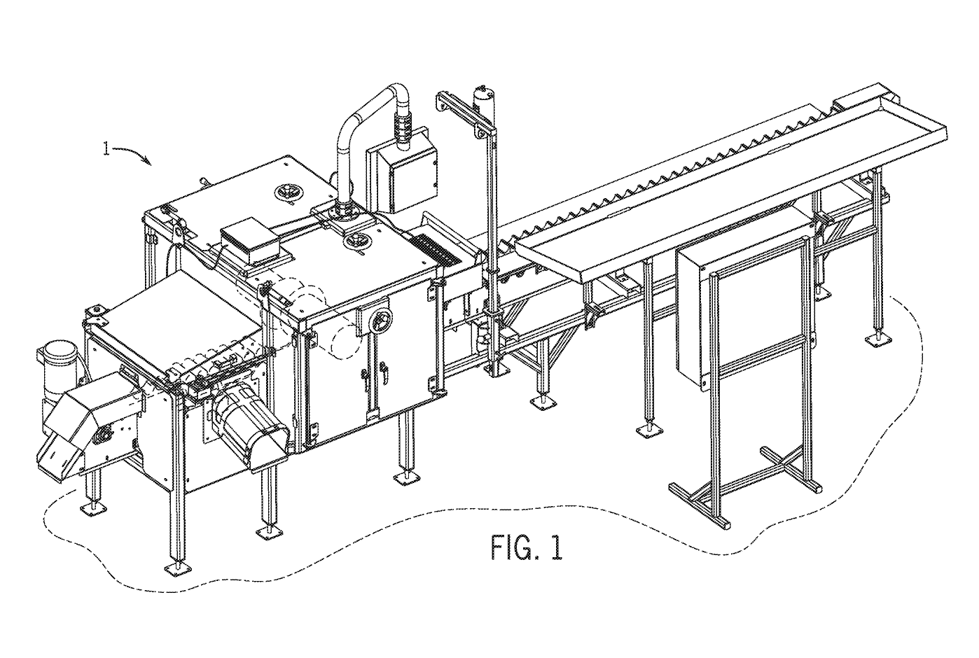

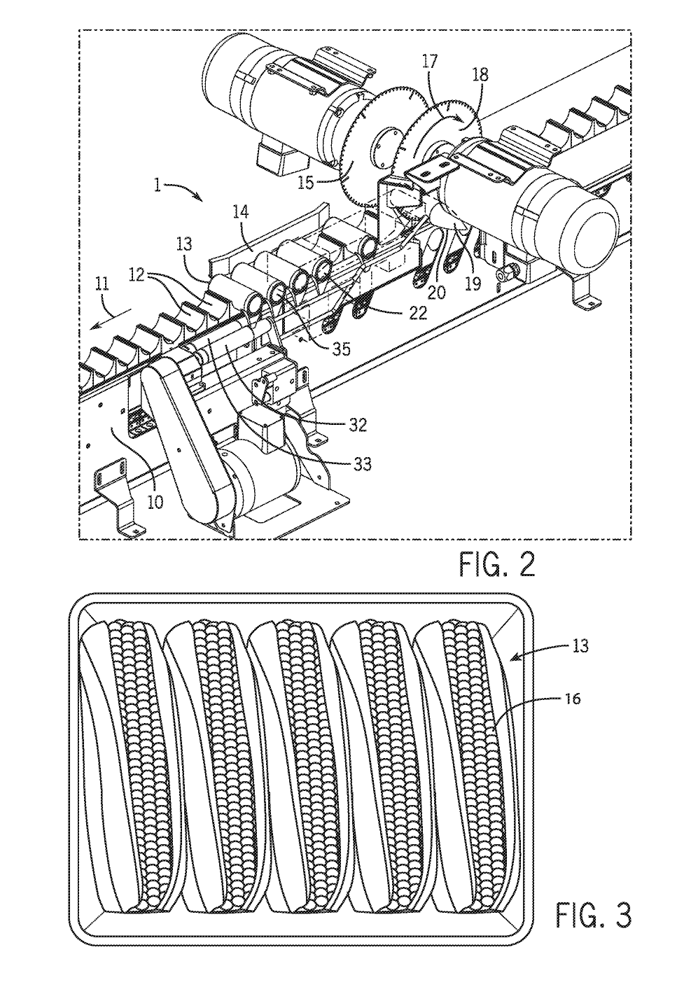

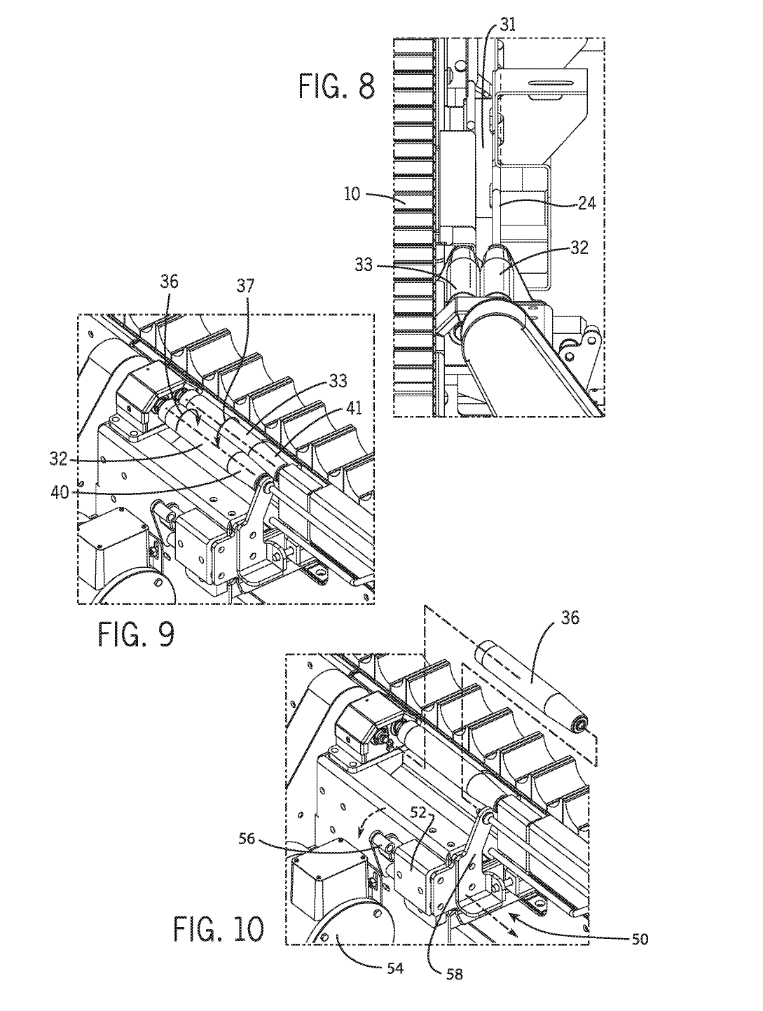

The present invention relates to an apparatus and method for partially husking corn on a conveyor line to expose some of the kernels of corn in a “window” cut through the husk. As shown in FIGS. 1-12, the automatic corn husker 1 includes a conveyor 10 having multiple sets of trough blocks 12. In the embodiment shown, the trough blocks 12 are semi-cylindrical in shape, that is, semi-circular in cross-section; but any suitable shape may alternatively be used. The trough blocks 12 ears of corn 13 as they travel through multiple operations within the automatic corn husker 1. Conveyor 10 moves in the direction shown by arrow 11 which is transverse to the corn's axis. In the embodiment shown, a crosscut end blade 18 partially trims the outer husk 20 at the crosscut end 19 of the ear of corn 13. Preferably, the crosscut end blade 18 cuts approximately 80% of the outer husk 20 and fully severs a portion of the crosscut end 19, which exposes a face 35 of the cob 22. In the embodiment shown, crosscut end blade 18 rotates in the direction shown by arrow 17. In alternative embodiments, crosscut end blade 18 may cut more or less of the outer husk 20 as desired. Although crosscut end blade 18 is circular in the present embodiment, any other suitable cutting tool may be used without departing from the invention.

The embodiment shown also includes an optional butt end blade 15, which trims the butt end 13a of the ear of corn 13. Both butt end blade 15 and crosscut end blade 18 are driven by at least one motor and rotate in the same direction as shown by arrow 23. Of course, although butt end blade 15 is shown as a circular blade, any suitable cutting tool may be used without departing from the invention. By aligning the butt end blade 15 and the crosscut end blade 18 on opposite sides of the conveyor 10, the ear of corn 13 is cut on both ends at the same time, which prevents rotation of the ear of corn as it is cut. It is important to prevent rotation so that a partially severed tip 21 falls down, due to gravity, thereby exposing the cob 22, and helping to align the un-severed portion of husk 29 with a set of pinch rollers 32, 33. Crosscut end blade 18 and butt end blade 15 may be adjusted up and down, as well as left and right to allow the user to dial-in the precise location of a desired cut. The blades 18, 15 may also be positioned so that the automatic corn husker 1 may perform as a standard cob saw, i.e. where both ends are completely removed and the cob 22 is completely husked.

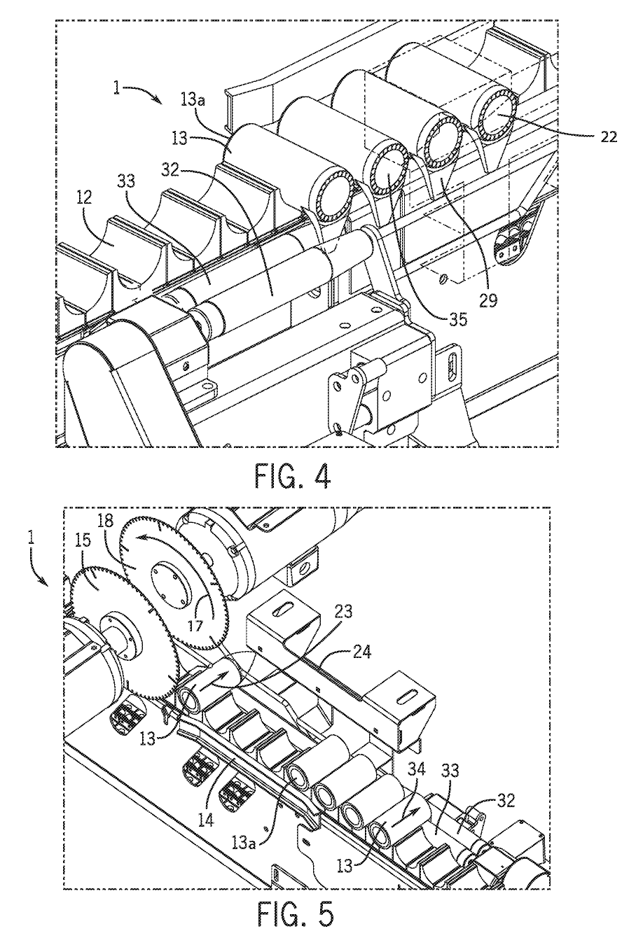

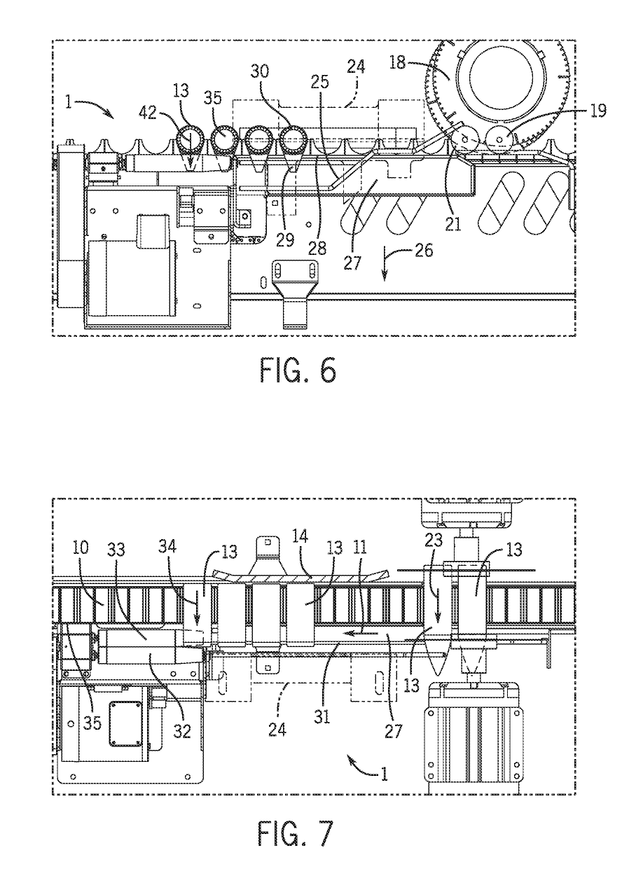

Downstream from butt end blade 15 and crosscut end blade 18 is a cob pusher 14 having a ramp portion 14a. When the butt end 13a of the cob 22 contacts the ramp portion 14a, the ears of corn 13 move longitudinally toward a guide bar 24. The direction of the movement of ear of corn 13 is shown as arrow 23. This movement will allow a face 35 of the partially severed ear of corn to be aligned with the subsequent actions. As ear of corn 13 moves further downstream, the ramped lower edge 25 of the guide bar 24 forces the partially severed tip 21 of the ear of corn 13 downward as shown in FIG. 4. This causes the un-severed portion of husk 29 to roll over the edge 28 of the inner guide block 27 causing the partially severed tip 21 break away from the cob 22 of the ear of corn 13. As the ear of corn 13 moves downstream the un-severed portion of husk 29 is fed into channel 31 between the guide bar 24 and inner guide block 27 as shown in FIG. 6.

As shown in FIGS. 4-7, with the un-severed portion of husk 29 guided by channel 31, the ear of corn 13 proceeds downstream to the pinch rollers 32, 33. In the embodiment shown, the pinch rollers 32, 33 are located on a crosscut end side 35 of the conveyor 10 and their rotational axes are oriented parallel to the movement of the conveyor. The pinch rollers 32, 33 are rotated in the opposite directions as shown by the arrows 36 and 37. The forward ends 38, 39 of the pinch rollers 32, 33 are radially tapered from a small diameter, forward section to a large diameter, main section on the body of the pinch rollers.

The un-severed portion of husk 29 is fed into the mouth of the pinch rollers 32, 33 defined by the tapered forward ends 40, 41 of the pinch rollers by channel 31. Since the conveyor 10 is moving in direction 11 and since the pinch rollers 32 and 33 are counter-rotating in directions 36 and 37, the un-severed portion of husk 29 is trapped between the counter-rotating pinch rollers and is removed or stripped from ear 13. This is removal is accomplished by transversely pulling the un-severed portion of husk 29 away from the horizontally supported main ear portion of ear of corn 13. This transverse pulling is in the direction shown by arrow 42 shown in FIG. 6, that is, transverse to the ear or corn's 13 axis. Because the counter-rotating pinch rollers 32, 33 transversely remove or pull un-severed portion of husk 29 away from ear of corn 13, the ear concurrently moves longitudinally along its axis in the direction shown by arrow 34. The stripping of the un-severed portion of husk 29 causes ejectment of the ear of corn 13 from the trough blocks 12 on the conveyor 10. The resulting achievement is an entire longitudinal strip of corn husk removed from the ear of corn 13, which exposes a strip of kernels 16.

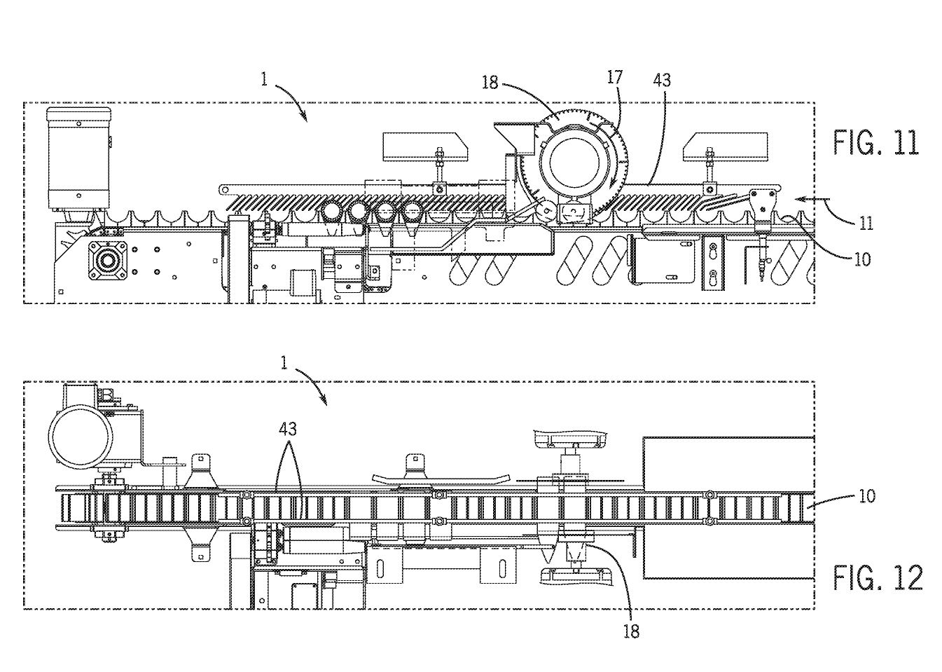

FIGS. 11 and 12 show a biasing mechanism 43 for holding the corn 13 in the trough blocks 12 of the conveyor 10. Crosscut end blade 18 rotates in the direction shown by arrow 17. Conveyor 10 moves in the direction shown by arrow 11. The biasing mechanism 43 biases the corn ears toward the horizontal plane of the base of conveyor 10 immediately before the crosscut end blade 18. Biasing mechanism 43 is immediately upstream or aligned with crosscut end blade 18 in order to keep the main portion of the ear in the trough block 12 while the partially severed tip 21 is cut. As shown, biasing mechanism 43 includes a plurality of fingers 44, but any suitable configuration may be used without departing from the invention.

Yet another feature of the present invention is a quick-change mechanism 50 for replacing the pinch rollers 32, 33 without tools, and with only minimal machine downtime. As shown in FIG. 10, the quick-change mechanism 50 includes a base 52 to which a motor 54 is attached. In the embodiment shown, the motor 54 is a conventional electric motor, but any suitable motor may be used without departing from the invention. A drive pulley is attached to the driveshaft of the motor 54. A belt engages the drive pulley, and a roller pulley, which is rotationally engaged to the pinch rollers 32, 33, thereby transferring energy from the motor to the pinch rollers 32, 33. To replace the pinch rollers 32, 33, a user simply disengages a locking tab 56 located near the tapered end of the pinch rollers. The locking tab 56 selectively locks end plate 58 in a locked position that engages the pinch rollers 32, 33, and an unlocked position that allows the pinch rollers to be removed.

It should also be noted that all of the components of the present invention may be attached to either side of the conveyor 10, which allows the automatic corn husker 1 to be set-up for an operation where the crosscut end is placed on the left side of the conveyor in the direction of travel, or alternatively where the crosscut end is placed on the right side of the conveyor in the direction of travel. Thus, the modularity of the various components allows an operator a great deal of flexibility when setting up the automatic corn husker 1.

Although the invention has been herein described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

What is claimed is:

1. An automatic corn husking machine for partially husking an ear of corn having a crosscut end and a butt end and including a cob to which a plurality of kernels is attached and a husk coveting the plurality of kernels, the automatic corn husking machine comprising:
a conveyor having a crosscut side and a butt end side;
a crosscut end blade positioned parallel to the crosscut side of the conveyor and further positioned so that when the ear of corn passes under the crosscut end blade, the crosscut end blade cuts a portion of the husk and also fully severs a tip portion of the cob, leaving the severed tip portion hanging inside the partially cut husk hanging along the crosscut side of the conveyor;
a cob pusher positioned downstream from the crosscut end blade that pushes the ear of corn toward a guide plate;
an inner guide block that causes the tip portion to be completely removed from the husk, but leaving an un-severed portion of the husk intact;
a pair of pinch rollers positioned downstream from the guide plate and inner guide block, the pair of rollers positioned to accept the un-severed portion of husk; and
wherein the pair of pinch rollers rotate in opposing directions and are positioned to engage the un-severed portion of husk to remove the un-severed portion of husk from the ear of corn, thereby exposing a strip of kernels on the cob.

2. The automatic corn husking machine of claim 1, wherein the conveyor further includes a plurality of trough blocks.

3. The automatic corn husking machine of claim 2, wherein each of the plurality of trough blocks has a generally cylindrical shape that supports the ear of corn.

4. The automatic corn husking machine of claim 1, wherein a butt end blade is positioned parallel to the butt end side of the conveyor and further positioned so that when an ear of corn passes under the butt end blade it fully trims the butt end of the ear of corn.

5. The automatic corn husking machine of claim 1, wherein the pinch rollers are driven by a belt drive pulley that is rotationally engaged to a motor.

6. The automatic corn husking machine of claim 5, wherein the motor is a conventional electric motor.

7. The automatic corn husking machine of claim 5, wherein the pinch rollers are removably attached to the belt drive pulley by a quick change mechanism.

8. The automatic corn husking machine of claim 7, wherein the quick change mechanism includes a locking tab that selectively engages an end plate in either a locked or unlocked position.
